(19) United States
(12) Patent Application Publication
(10) Pub. No.: US 2021/0234851 A1
(43) Pub. Date: Jul. 29, 2021

(54) INFORMATION COLLECTION SYSTEM AND INFORMATION COLLECTION METHOD

(71) Applicant: Shimadzu Corporation, Kyoto (JP)

(72) Inventors: Teppei KODAMA, Kyoto (JP); Xi LI, Kyoto (JP); Kiyoyuki NISHIWAKI, Kyoto (JP); Takeshi YOSHIDA, Kyoto (JP)

(21) Appl. No.: 17/154,951

(22) Filed: Jan. 21, 2021

(30) Foreign Application Priority Data
Jan. 23, 2020 (JP) 2020-009058

(51) Int. Cl. H04L 29/06

(52) U.S. Cl. CPC H04L 63/083; H04L 63/0823

(57) ABSTRACT

The information collection system is provided with an information collection server, a management server, and a communication device and collects information of an analysis device. The information collection server acquires the information about the analysis device and stores it. The management server stores the user information of the owner of the analysis device. The communication device can communicate with the information collection server and transmits the information about the analysis device to the information collection server. When the first authentication information transmitted from the communication device matches the second authentication information corresponding to the communication device stored in the information collection server, the information collection server acquires and stores the information about the analysis device transmitted from the communication device. The information collection server generates authentication information to be set to the communication device based on the user information stored in the management server.

### CROSS-REFERENCE TO RELATED APPLICATIONS

This application claims priority under 35 U.S.C. § 119 to Japanese Patent Application No. 2020-009058 filed on Jan. 23, 2020, the entire disclosure of which is incorporated herein by reference in its entirety.

### BACKGROUND OF THE INVENTION

### Field of the Invention

The present invention relates to an information collection system and an information collection method, and more particularly to a technique for conveniently setting authentication information in a system of collecting information about an analysis device by a server.

### Description of the Background Art

Traditionally, services using information (data) communication via a communication network, such as, e.g., the Internet, are known. For example, Japanese Unexamined Patent Application Publication No. 2002-073399 (Patent Document 1) discloses a system for safely delivering analysis data to a user via the Internet in an analysis service of a sample received an order from a user. In the system disclosed in Japanese Unexamined Patent Application Publication No. 2002-073399 (Patent Document 1), highly sensitive information can be safely provided even through an open system, such as, e.g., the Internet, by performing authentication processing using a user ID and a password to restrict access to the user directory.

### PRIOR ART DOCUMENT

### Patent Document

Patent Document 1: Japanese Unexamined Patent Application Publication No 2002-073399

### SUMMARY OF THE INVENTION

### Problems to be Solved by the Invention

In recent years, with the development of IoT (Internet of Things), a system for storing various data in a server installed on a cloud or other sites via the Internet has been widely used. For example, there is a maintenance management system of an analysis device that manages the state of each analysis device by acquiring the information from the analysis device delivered to the user via the Internet and makes a maintenance plan, etc. In such a system, since confidential information of a user is handled, authentication processing for data exchange is required as in Patent Document 1 described above.

In such a maintenance management system, in some cases, a server for managing the user information (hereinafter also referred to as “management server”) and a server for collecting information from an analysis device owned by a user (hereinafter also referred to as “information collection server”) are separately provided. In this situation, in order to perform authentication processing for communication between the analysis device owned by the user and the information collection server, the analysis device and the information collection server must register the information about the opposite device with each other as default setting. However, in a system in which the management server and the information collection server are provided separately, since the user information used for authentication is managed by the management server, when performing the default setting, generation of the authentication information based on the user information and setting of the authentication information to each device must be performed manually. This may require a lot of effort.

The present invention has been made to solve the above-described problems, and an object of the present disclosure is to provide an information collection system for collecting information about an analysis device owned by a user in which setting for authentication processing can be simply performed.

### Means for Solving the Problem

The information collection system according to the first aspect of the present invention is provided with a first server, a second server, and a communication server and collects the information of an analysis device. The first server is configured to acquire and store the information about the analysis device. The second server stores user information of an owner of the analysis device. The communication device is capable of communicating with the first server and is configured to transmit the information about the analysis device to the first server. The first server acquires and stores the information of the analysis device transmitted from the communication device when first authentication information transmitted from the communication device and second authentication information corresponding to the communication device stored in the first server match with each other. The first server generates authentication information to be set to the communication device based on the user information stored in the second server.

According to the information collection method according to the second aspect of the present invention, in a system including a communication device capable of communicating with an analysis device, a first server, and a second server, the method collects the information about the analysis device. The method includes: i) a step of storing user information about an owner of the analysis device in the second server; ii) a step of acquiring device information about the communication device by the second server; iii) a step of generating authentication information for permitting communication between the first server and the communication device in the first server based on the user information and the device information; iv) a step of storing the authentication information generated by the first server in the communication device; v) a step of transmitting information about the analysis device acquired by the communication device from the communication device to the first server together with the stored authentication information; and vi) a step of storing the information about the analysis device transmitted from the communication device to the first server when the authentication information corresponding to the communication device stored in the first server and the authentication information transmitted from the communication device match with each other.

### Effects of the Invention

In the information collection system according to the present invention, the information collection server (first server) and the management server (second server) are provided separately, and the authentication information used between the communication device connected to the analysis device and the information collection server is automatically generated by the information collection server based on the information in the management server. Therefore, it is possible to make setting for the authentication processing easily in the information collection system.

### BRIEF DESCRIPTION OF THE DRAWINGS

FIG. 1 is an entire configuration diagram of an information collection system according to the present embodiment.

FIG. 2 is a flowchart for explaining the processing performed by the communication device, the management server, and the information collection server in the information collection system of FIG. 1.

FIG. 3 is a diagram showing an example of device information of the analysis device.

FIG. 4 is a diagram showing an example of user information and device information transmitted from the management server to the information collection server.

FIG. 5 is a diagram showing an example of the authentication information transmitted from the information collection server to the management server.

FIG. 6 is a diagram showing an example of operation information and consumable article information of the analysis device transmitted from the communication device to the management server.

### EMBODIMENTS FOR CARRYING OUT THE INVENTION

Hereinafter, some embodiments of the present invention will be described in detail with reference to the attached drawings. Note that in the drawings, the same or corresponding portions are denoted by the same reference numerals, and the description thereof will not be repeated.

### Configuration of Information Collection System

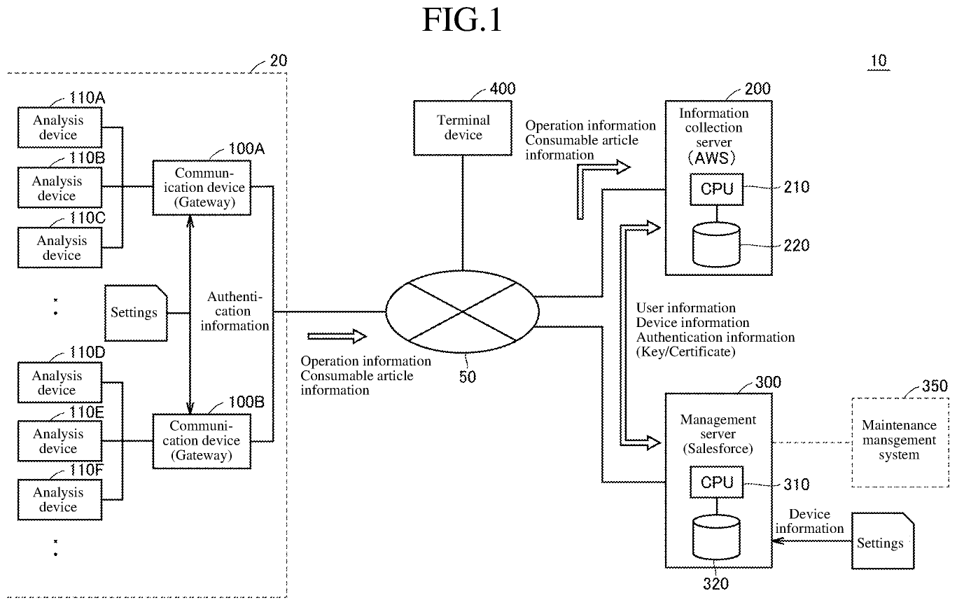

FIG. 1 is an entire configuration diagram of an information collection system 10 according to this embodiment. The information collection system 10 is, for example, a system for performing maintenance management of an analysis device delivered to a user, and accumulates various information from each analysis device to make a maintenance plan and the like.

Referring to FIG. 1, the information collection system 10 includes analysis devices 110 and communication devices 100 installed in a user facility 20, such as, e.g., a plant and a laboratory, an information collection server 200 (first server), and a management server 300 (second server). The information collection server 200 and the management server 300 are typically located outside the user facility 20. The information collection server 200 and the management server 300 may be, for example, a dedicated server located within a facility of a contractor performing the maintenance management or an openly usable cloud server. The communication device 100, the information collection server 200, and the management server 300 are configured to be able to communicate with each other via a communication network 50, represented by the Internet.

In the user facility 20, at least one communication device 100 is installed, and at least one analysis device 110 is connected to each communication device. In the example of FIG. 1, the communication devices 100A and 100B are arranged, the analysis devices 110A to 110C are connected to the communication device 100A, and analysis devices 110D to 110F are connected to the communication device 100B. The analysis device 110 may be, for example, but not limited to, a gas chromatograph, a liquid chromatograph, a mass spectrometer, a non-destructive testing device, an X-ray imaging system, a spectrophotometer, or a total organic carbon-based system.

The communication device 100 has a so-called gateway function and is wired or wirelessly connected to the communication network 50 to transmit and receive information. The communication device 100 acquires the operation information and the consumable article information from each analysis device 110 and transmits the acquired information to the information collection server 200 via the communication network 50. Also, as will be described later, the communication device 100 performs authentication processing with the information collection server 200 when transmitting the information to the information collection server 200. This authentication processing prevents unauthorized access to certain areas within the information collection server 200.

The information collection server 200 includes a CPU 210, which is a controller, and a storage device 220. The CPU 210 collects information about the analysis device transmitted from the user facility 20 via the communication network 50 and stores it in the storage device 220. For example, an AWS (Amazon Web Services) can be used as the information collection server 200.

The storage device 220 may be, for example, an HDD (Hard Disc Drive), an SSD (Solid State Disc), or a mass memory. In the storage device 220, a storage area is set in advance for each user, and only the user (device) permitted by the authentication processing can be accessible to each storage area. Note that the storage device 220 in the information collection server 200 is required to store the information of each analysis device transmitted from a large number of users in the time-series order. Therefore, the storage capacity of the storage device 220 is greater than the storage capacity of the storage device 320 (described later) included in the management server 300.

The management server 300 is a server for storing and managing the user information of the owner of the analysis device 110. As the management server 300, for example, Salesforce may be used. The management server 300 includes a CPU 310, which is a controller, and a storage device 320.

In the management server 300, the user information for specifying the user and the device information about the analysis devices 110 that have been delivered to the respective users and the communication devices 100 are input by the administrator of the management server 300. The CPU 310 automatically generates an identification code (device ID) for identifying each analysis device 110 and an identification code (GW-ID) for identifying each communication device 100 from the user information and the device information. These identification codes are set uniquely for each device.

The storage device 320 stores an identification code for each of the analysis devices 110 and the communication devices 100 in addition to the user information and the device information described above. Further, when the management server 300 is connected to a maintenance management system 350, the contract information regarding the maintenance management contracted with the user is also stored as user information.

The management server 300 is configured to be able to communicate with the information collection server 200 via the communication network 50 as described above. The management server 300 transmits the user information and the device information stored in the storage device 320 to the information collection server 200.

The information collection server 200 generates and stores the authentication information for use in the authentication processing with the communication device 100 of each user facility 20 based on the user information and the device information transmitted from the management server 300. The authentication information includes key information and certificate information for the authentication key. The information collection server 200 transmits the generated authentication information to the management server 300.

In the management server 300, the authentication information acquired from the information collection server 200 is stored, and the information is output to an outside as a data file (settings). The data file may be output as electronic information to an external storage medium, such as, e.g., a USB memory, or may be printed on a paper medium. The output authentication information is set by a service engineer to the communication device 100 of the user facility 20. Each communication device 100 performs authentication processing between the communication device 100 and the information collection server 200 based on the set authentication information.

The information collection server 200 and the management server 300 are accessible from a terminal device 400 connected to the communication network 50. The terminal device 400 is, for example, a computer owned by a user or a computer owned by a service engineer. The user and/or the service engineer can access the data of the user corresponding to the authentication information in the information collection server 200 and the management server 300 by inputting the key information and the certificate information to a predetermined web browser.

In the system in which the information collection server and the management server are arranged separately as shown in FIG. 1, conventionally, at the time of initially setting the system, in some cases, the identification code for each user device (analysis device/communication device) and the authentication information between the communication device and the information collection server are manually generated by the service engineer or the administrator of the management server.

On the other hand, in the information collection system 10 of this embodiment, the identification code for each device is automatically generated in the management server 300. In addition, in the information collection system 10, the authentication information between the communication device 100 and the information collection server 200 is automatically generated in the information collection server 200 based on the information from the management server 300. Therefore, in the information collection system 10 according to this embodiment, it is possible to enhance the convenience in the initial setting of the authentication processing data of the system.

### [Processing Details in Each Device]

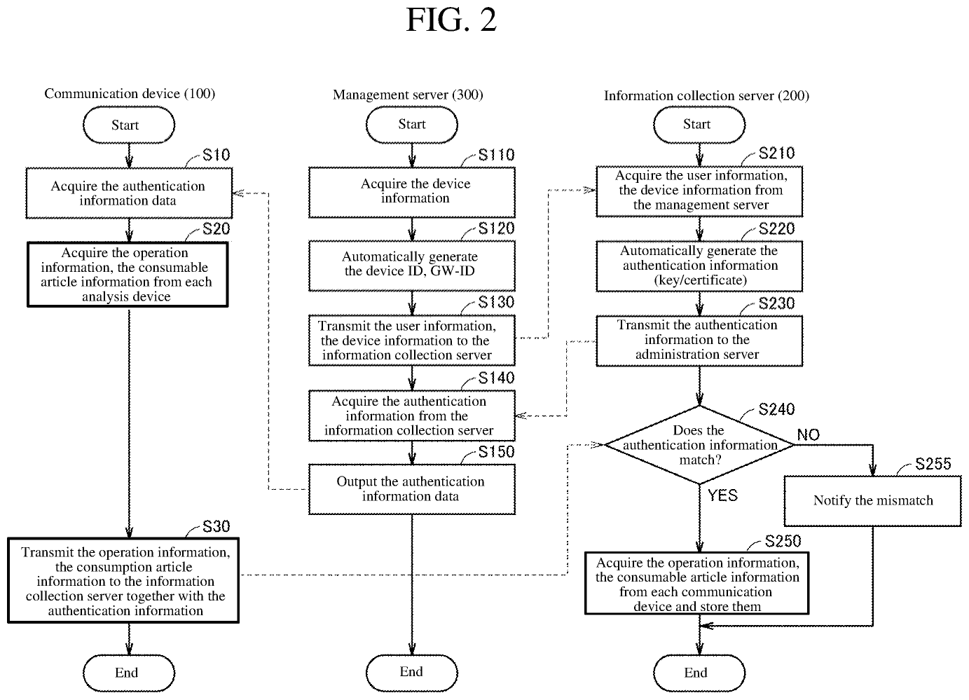

Next, with reference to FIG. 2, the processing details in each device of the information collection system 10 will be described in detail. FIG. 2 is a flowchart for explaining the processing performed in the communication device 100, the information collection server 200, and the management server 300 in the information collection system 10 of FIG. 1.

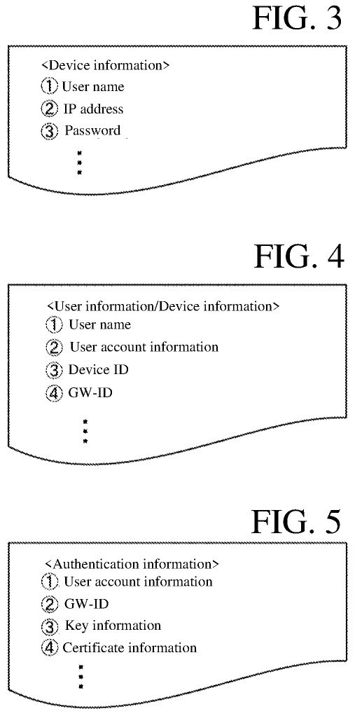

First, the management server 300 acquires the device information of the communication device 100 and the analysis device 110 in the user facility 20 by the operations of the administrator or the service engineer of the management server 300 in Step (hereinafter, Step is abbreviated as S) 110. For example, as shown in FIG. 3, the device information includes a user name, an IP address of each device, and a password.

Referring again to FIG. 2, the management server 300 automatically generates an identification code (GW-ID) of each communication device 100 and an identification code (device ID) of each analysis device 110 based on the acquired device information and the user information registered in advance and stores them in the storage device 320 in S120. Then, the management server 300 transmits the acquired device information and the user information including the generated identification code to the information collection server 200 via the communication network 50 (S130).

FIG. 4 is an example of information transmitted from the management server 300 to the information collection server 200. The information includes, for example, a user name, user accounting information, a device ID, and a GW-ID.

Referring again to FIG. 2, the information collection server 200 acquires the use information and the device information from the management server 300 in S210. Then, in S220, based on the information, the information collection server 200 automatically generates authentication information (key information/certificate information) for allowing access to the area storing the user information. In the information collection server 200, the generated authentication information is stored in association with the storage area of the corresponding user. The information collection server 200 transmits the generated authentication information to the management server 300 via the communication network 50 in S230.

FIG. 5 is an example of authentication information transmitted from the information collection server 200 to the management server 300. The authentication information includes the user account information, the GW-ID, the key information, and the certificate information.

Referring again to FIG. 2, when the management server 300 acquires the authentication information from the information collection server 200 (S140), it outputs the acquired authentication information data to an external storage medium or a printed medium in S150.

The communication device 100 acquires the authentication information output to the external medium by the operation of the service engineer (S10). In S20, the communication device 100 acquires the operation information and the consumable article information of the analysis device from each analysis device 110 connected to the communication device 100. Thereafter, in S30, the communication device 100 transmits the information related to the acquired analysis device together with the authentication information acquired in S10 to the information collection server 200. Note that obtaining the operation information and the consumable article information of the analysis device and transmitting the acquired information to the information collection server 200 are periodically repeated at predetermined intervals.

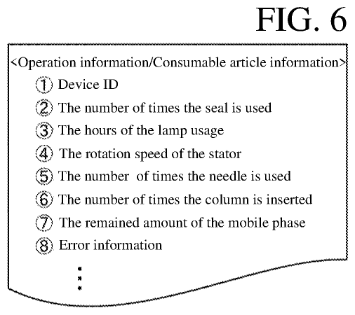

FIG. 6 is an example of the information regarding the analysis device transmitted from the communication device 100 to the information collection server 200. For example, in the case of liquid chromatograph, information regarding the analysis device includes, for example, the device ID of the relevant analysis device 110, the number of times the seal of the pump is used, the number of times the lamp is used in the column oven, the stator speed and the number of times the needle is used in the autosampler, the number of times the column injection and the mobile phase remaining mount, and the error information.

Referring again to FIG. 2, in S240, the information collection server 200 collates the authentication information transmitted together with the information regarding the analysis device with the authentication information stored in the information collection server 200 to determine whether or not the two pieces of authentication information match. When the two pieces of authentication information match (YES in S240), the processing proceeds to S250, and the information collection server 200 allows access to the given storage area corresponding to the user and stores the operation information and the consumable article information of the analysis device 110 transmitted from the communication device 100 in a corresponding storage area.

On the other hand, when the two pieces of authentication information do not match (NO in S240), the process proceeds to S255, and the information collection server 200 prohibits the user from accessing the storage area and notifies the communication device 100 that authentication information does not match.

In accordance with the above-described processing, each device is controlled, so that the identification code and the authentication information of the user device are automatically generated by the server. This allows the information collection system to easily configure settings for authentication processing. Furthermore, the operation information and the consumable article information of the analysis device can be collected and stored using the authentication information, and therefore the information can be safely transmitted while ensuring confidentiality.

### [Aspects]

It will be understood by those skilled in the art that the plurality of exemplary embodiments described above is illustrative of the following aspects.

### (Item 1)

An information collection system according to one aspect of the present invention is provided with a first server, a second server, and a communication device and collects the information about an analysis device. The first server is configured to acquire and store the information about the analysis device. The second server stores user information of an owner of the analysis device. The communication device is capable of communicating with the first server, the communication device being configured to transmit the information about the analysis device to the first server. The first server acquires and stores the information of the analysis device transmitted from the communication device when first authentication information transmitted from the communication device and second authentication information corresponding to the communication device stored in the first server match with each other. The first server generates authentication information to be set to the communication device based on the user information stored in the second server.

According to the information collection system as recited in the above-described Item 1, the authentication information used for the authentication processing between the system and the communication device is automatically generated in the first server based on the user information of the second server. Therefore, in the information collection system, it is possible to easily configure the settings for authentication processing.

### (Item 2)

In the information collection system as recited in the above-described Item 1, the second server generates an identification code of the analysis device and that of the communication device based on the user information stored in the second server in advance and device information about the analysis device and that about the communication device input to the second server.

According to the information collection system as recited in the above-described Item 2, in the second server, the identification codes for the analysis device and the communication device are automatically generated based on the user information and the device information. Therefore, in the information collection system, it is possible to easily configure the settings for authentication processing.

### (Item 3)

In the information collection system as recited in the above-described Item 2, the second authentication information generated by the first server and the identification code generated by the second server are registered in the communication device. The communication device generates the first authentication information based on information registered in the communication device when the information about the analysis device is transmitted to the first server.

According to the information collection system as recited in the above-described Item 3, authentication processing is performed using the authentication information preset for the communication device in the first server when the communication device transmits the information about the analysis device to the first server. This can increase the security of communication between the communication device and the first server.

### (Item 4)

In the information collection system as recited in any one of the above-described Items 1 to 3, each of the first authentication information and the second authentication information includes key information and certificate information.

### (Item 5)

The information collection system as recited in any one of the above-described Items 1 to 4, the information about the analysis device includes operation information and consumable article information of the analysis device.

### (Item 6)

The information collection system as recited in any one of the above-described Items 1 to 5, a storage capacity of the first server is greater than a storage capacity of the second server.

According to the information collection system as recited in the above-described Item 6, the storage capacity of the first server is set greater than the storage capacity of the second server. The first server is a server for storing the time series data of the analysis device, and the second server is a server for storing fixed data, such as, e.g., user information. This allows servers to operate properly by allowing the first server of the two servers to be larger than the second server.

### (Item 7)

A method of collecting information according to another aspect of the present invention is a method of collecting the information of an analysis device in a system including a communication device capable of communicating with the analysis device, a first server, and a second server. The method includes: i) a step of storing user information about an owner of the analysis device in the second server; ii) a step of acquiring device information about the communication device by the second server; iii) a step of generating authentication information for permitting communication between the first server and the communication device in the first server based on the user information and the device information; iv) a step of storing the authentication information generated by the first server in the communication device; v) a step of transmitting the information about the analysis device acquired by the communication device from the communication device to the first server together with the stored authentication information; and vi) a step of storing the information about the analysis device transmitted from the communication device to the first server when the authentication information corresponding to the communication device stored in the first server and the authentication information transmitted from the communication device match with each other.

According to the information collection method as recited in the above-described Item 7, the authentication information to be used for authentication processing between the system and the communication device is automatically generated in the first server based on the user information in the second server. Therefore, in the information collection system, it is possible to easily perform the settings for authentication processing.

The embodiments disclosed herein are to be considered in all respects as illustrative and not restrictive. The present invention is indicated by the appended claims rather than by the descriptions of the embodiments set forth above, and is intended to include all modifications within the meanings and ranges equivalent to the scope of the claims.

### DESCRIPTION OF SYMBOLS

10: Information collection system
20: User facility
50: Communication network
100, 100A, 100B: Communication device
110, 110A to 110F: Analysis device
200: Information collection server
220, 320: Storage device
300: Management server
350: Maintenance management system
400: Terminal device

1. An information collection system for collecting information about an analysis device, comprising:
a first server configured to acquire and store the information about the analysis device;
a second server in which user information of an owner of the analysis device is stored; and
a communication device capable of communicating with the first server, the communication device being configured to transmit the information about the analysis device to the first server,
wherein the first server acquires and stores the information of the analysis device transmitted from the communication device when first authentication information transmitted from the communication device and second authentication information corresponding to the communication device stored in the first server match with each other, and
wherein the first server generates authentication information to be set to the communication device based on the user information stored in the second server.

2. The information collection system as recited in claim 1,
wherein the second server generates an identification code of the analysis device and that of the communication device based on the user information stored in the second server in advance and device information about the analysis device and that about the communication device input to the second server.

3. The information collection system as recited in claim 2,
wherein the second authentication information generated by the first server and the identification code generated by the second server are registered in the communication device, and
wherein the communication device generates the first authentication information based on information registered in the communication server when the information about the analysis device is transmitted to the first server.

4. The information collection system as recited in claim 1,
wherein each of the first authentication information and the second authentication information includes key information and certificate information.

5. The information collection system as recited in claim 1,
wherein the information about the analysis device includes operation information and consumable article information of the analysis device.

6. The information collection system as recited in claim 1,
wherein a storage capacity of the first server is greater than a storage capacity of the second server.

7. A method of collecting information about an analysis device in a system including a communication device capable of communicating with the analysis device, a first server, and a second server, the method comprising:
a step of storing user information about an owner of the analysis device in the second server;
a step of acquiring device information about the communication device by the second server;
a step of generating authentication information for permitting communication between the first server and the communication device in the first server based on the user information and the device information;
a step of storing the authentication information generated by the first server in the communication device;
a step of transmitting the information about the analysis device acquired by the communication device from the communication device to the first server together with the stored authentication information; and
a step of storing the information about the analysis device transmitted from the communication device to the first server when the authentication information corresponding to the communication device stored in the first server and the authentication information transmitted from the communication device match with each other.
